(19) United States
(12) Patent Application Publication
(10) Pub. No.: US 2023/0249224 A1
(43) Pub. Date: Aug. 10, 2023

(54) APPARATUS AND METHOD FOR SEPARATING OR SORTING A SET OF PARTS

(71) Applicant: MICRO RECYCLING SYSTEMS L.L.C., Washington, DC (US)

(72) Inventor: Mario Urdaneta, Washington, DC (US)

(21) Appl. No.: 18/163,085

(22) Filed: Feb. 1, 2023

Related U.S. Application Data
(63) Continuation-in-part of application No. 17/221,802, filed on Apr. 4, 2021.

(51) Int. Cl. B07C 5/36; B07C 5/34; B07C 5/16

(52) U.S. Cl. CPC B07C 5/362; B07C 5/16; B07C 5/34; B07C 2501/0036

(57) ABSTRACT

There is provided an apparatus including a fluidic section that comprises an input section. The fluidic section receives a fluid including a plurality of machined particles at the input section. The fluidic section receives the fluid at an inlet port of the fluidic section. The fluidic section may include two branches extending from the input section, and each of these branches has an outlet through which the fluid or part of the fluid can be routed. The apparatus can include a set of sensors configured to capture information about the plurality of machined particles in the fluidic section. The apparatus can further include channels with flow in the same and opposite directions of gravity, with each of these having one or more branches extending from the channels oriented with gravity, and each of these branches can have an outlet through which the fluid or part of the fluid can be routed.

### CROSS-REFERENCE TO RELATED APPLICATIONS

This application is a continuation-in-part of co-pending U.S. Pat. Application No. 17/221,802 titled “APPARATUS AND METHOD FOR SEPARATING OR SORTING A SET OF PARTS,” filed by the inventor herein on Apr. 4, 2021, the specification of which is incorporated herein by reference in its entirety.

### FIELD OF THE INVENTION

The present invention relates generally to the field of separation and sorting of materials, and more particularly to an apparatus and method for separating and sorting of parts to be processed and/or recycled as scrap materials, such as scrap metal components that are shredded or otherwise processed from their original component configurations into smaller elements.

### BACKGROUND

The background description provided herein is for the purpose of generally presenting the context of the disclosure. The work of the presently named inventor, to the extent it is described in this background section, as well as aspects of the description that may not otherwise qualify as prior art at the time of filing, are neither expressly nor impliedly admitted as prior art against the present disclosure.

Typical machines for sorting materials in the recycling industry separate parts of materials simultaneously as the parts are exposed to the effect that underpins the separation. These typical machines may feature electromagnets and Eddy current separators (for separating according to the material’s response to electromagnetic fields), electrostatic separators (for separating according to whether the material is electrically conductive or not), and flotation tanks and shake tables.

These systems and their analogues have several disadvantages. They lack precision for discriminating material properties, so they sort on an “all or nothing” basis. For example, these machines may not be capable of differentiating between different types of non-ferrous metals or between different types of insulating materials, and to compensate for this low fidelity, industry supply chains are shaped to avoid combination of materials that in the real world are often used together because they are hard to separate and poison each other during reprocessing (e.g., steel and copper). Furthermore, these typical machines have difficulty in predicting the position of a material being sorted once it is affected by the forces that discriminate the material from other materials in the plurality of materials to be recycled. As such, machines have to choose between large machine size and low separation fidelity. Another disadvantage is that typical recycling systems are configured to process a large-volume of material (typically ranging from 1 ton/hour to 50 tons/hour). As such, they are inadequately large for single sources of waste (e.g., individual factories, or individual households) and thus they are used in centralized operations to where waste from many sources is brought. Lastly, typical recycling systems may be undesirable for people to be near them because of concerns about noise, vibration, or because they are large and unsightly.

Another type of machine used in the recycling industry to sort materials operates through “sensor-based sorting” and as such rely on sensors that provide information for deciding whether a piece of material is of interest, and activate an actuator (typically jets of air, but more recently also robotic arms with suction cups) to separate that particular piece of material. A common configuration for sensor-based systems has material parts traveling on a conveyor belt that suddenly ends such that the parts become airborne and land in one of two bins. Air nozzles near the end of the conveyor belt produce puffs of air that affect the part trajectory to make it land in its intended bin. Unfortunately, the unique geometry of each part translates into slightly different forces exerted by the puff of air on each part and this puts inherent limits on the sorting fidelity of this approach, even if the material is identified accurately by the sensors.

Systems that rely on sensors may use one or more types of detectors, which typically include optical detectors (ranging in light wavelength from ultraviolet to infrared), x-ray detectors for capturing x-ray fluorescence resulting from excitation by an x-ray source in the system, or x-rays that travel through the materials. Optical sensors are only able to capture information from the surface of the material and are thus prone to be confused by films covering the material (such as dirt, oil, or paint) and by fragments that have more than one material.

X-ray fluorescence sensors are very good at identifying the elements in a material, but only up to a certain depth (typically less than 1 mm) since x-ray fluorescence originating from atoms deeper in the material are absorbed by the material itself before they can leave it. Additionally, in order to identify the materials properly the system must gather enough fluorescence photons so as to generate a satisfactory material fingerprint and relatively few fluorescence photons are generated compared to the amount illuminated on the material (because of the inefficiencies of fluorescence as well as self-absorption of deeply-generated fluorescence). For example, hand-held x-ray fluorescence systems also used in the recycling industry (but not the focus of this invention) gather x-ray fluorescence for approximately 1 minute before providing reliable material identification.

As a consequence, XRF-based sorting systems use very bright x-ray sources (which makes them hazardous and energy inefficient) in order to provide a strong fluorescence signal, and may also require relatively large sensing areas or move the material past the sensors slowly, such that the system has time to collect enough fluorescence x-rays.

X-ray absorbance systems have the advantage of collecting information through the entire depth of the material. However, x-ray absorbance systems used in the recycling industry focus on high-throughput of material, which means that the material being sorted can be several millimeters thick. As a consequence, such systems use high energy x-rays (i.e., 100 keV) in order for the x-rays to travel across the entire thickness of the material being sorted. High-energy x-rays require expensive sensors (e.g., scintillating crystals), heavy shielding around the sensing area, and are only able to discriminate coarsely according to atomic number because of tradeoffs in machine geometry, speed, and detection materials that have to be made to accommodate large processing capacity.

Furthermore, the attenuation of the x-rays will depend on the thickness of the material, not just the atomic composition, so an x-ray absorbance system may confuse low-Z/high-thickness with high-Z/low-thickness, thus requiring multi-sensor schemes to gain some degree of spectroscopic information.

### SUMMARY OF THE INVENTION

One or more embodiments of the present disclosure relate to sorting, separating, and/or extracting specific materials from a plurality of parts (or generally, machine-processed or “machined” particles). The one or more embodiments can help mitigate or solve the above-noted issues and other issues that are readily apparent to one of ordinary skill in the art.

For example, an embodiment as featured herein can include a machine that is configured to sort small amounts of recyclable material according to elemental composition with high fidelity. Elemental composition of a particle in this disclosure refers to the defining atomic elements present in a particle, i.e., the defining molecular structure of a particle. In certain exemplary configurations, and without limitation, the sorting throughput may be less than about 400 pounds/hour (lbs./hr).

According to certain aspects of an embodiment, there is provided an apparatus that includes a fluidic section having an input section. The fluidic section may be configured to receive a fluid that carries a plurality of machined particles at the input section. The fluidic section may direct machined particles to one or more branches extending from and in fluid communication with the fluidic section. The apparatus may include a set of sensors configured to capture information about the plurality of machined particles in the fluidic section. For example, the set of sensors may include one or more sensors configured to measure the elemental composition of the parts, i.e. the atomic composition of the parts. The apparatus may further include a set of actuators, such as by way of non-limiting example one or more pumps and valves, configured to effect, based on the information, a change in a movement of a particular set of machined particles from the plurality of machined particles fed to the fluidic section such that the set of machined particles is distributed via the fluid to at least one of the at least two branches.

In accordance with further aspects of an embodiment, there is an assembly that includes a set of apparatuses. One or more apparatuses in the set may include a fluidic section having an input section. The fluidic section may be configured to receive a fluid that carries a plurality of machined particles at the input section. The fluidic section may direct machined particles to one or more branches extending from and in fluid communication with the fluidic section. The one or more apparatuses may include a control module configured to effect a change in a movement of a particular set of machined particles from the plurality of particles fed to the fluidic section such that the set of machined particles is distributed via the fluid to at least one of the at least two branches. The one or more apparatuses may include a mechanism configured to mate a first apparatus from the set of apparatuses with a second apparatus from the set of apparatuses.

According to yet further aspects of an embodiment, there is provided an apparatus that includes a fluidic section having an input section. The fluidic section may be configured to receive a fluid that carries a plurality of machined particles therein. The fluidic section may direct machined particles to one or more branches extending from the input section, such as by way of example one branch extending upwards and one branch extending downwards, such that machined particles lighter than the fluid will tend to move towards the branch or branches extending upwards while machined particles of materials that are heavier than the fluid will move towards the branch or branches extending downwards. The apparatus may include a control module configured to effect a change in a movement of a particular set of machined particles from the plurality of particles directed to the fluidic section such that the set of machined particles is distributed via the fluid to at least one of the at least two sets of branches. The control module may be configured to cause a force resulting from at least one of a dielectrophoretic force, an electrophoretic force, an electrodynamic force, and a magnetophoretic force to be exerted on the plurality of machined parts.

Still other aspects, features and advantages of the invention will be readily apparent from the following detailed description, simply by illustrating a number of particular embodiments and implementations, including the best mode contemplated for carrying out the invention. The invention is also capable of other and different embodiments, and its several details can be modified in various respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 illustrates a schematic view of an apparatus or system according to various aspects described herein.

FIGS. 1(a), 1(b), and 1(c) are detail views of an exemplary fluidic section for use in the apparatus or system of FIG. 1.

FIG. 2 illustrates an apparatus or system according to various aspects described herein.

FIG. 3 illustrates an assembly of apparatuses according to various aspects described herein.

FIG. 4 illustrates an assembly of apparatuses according to various aspects described herein.

FIG. 5 illustrates an assembly of apparatuses according to various aspects described herein.

FIG. 6 depicts a flow chart of a method according to various aspects described herein.

FIG. 7 illustrates a controller according to various aspects described herein.

FIG. 8 depicts a graph of information about machined particles captured by an apparatus according to various aspects described herein.

FIG. 9 depicts a graph of information about machined particles captured by an apparatus according to various aspects described herein.

FIG. 10 is a photograph of exemplary electromagnetic coils useful for capturing information about parts by an apparatus according to various aspects described herein.

FIG. 11 is a photograph of an apparatus according to various aspects described herein.

FIG. 12 is a photograph of sorted particles before and after processing by an apparatus according to various aspects described herein.

### DETAILED DESCRIPTION OF THE PREFERRED EMBODIMENTS

The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

Furthermore, the terms used herein are intended to describe embodiments only and shall by no means be restrictive. Unless clearly used otherwise, expressions in a singular form include a meaning of plural form. An expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

As previously stated, typical sorting technologies have low separation fidelity for materials with similar properties, are considered “all or nothing”, and are inherently big in size.

In contrast to typical sorting technologies, the present disclosure features embodiments that are able to differentiate between materials of different composition and sort them with precision. Additionally, in an exemplary embodiment, because the material is to be provided to the sorting system as small particles (for example, and not by limitation, as particles having their longest dimension being less than about 20 millimeters (mm)) the different groups of sorted material originating from assemblies of mixed materials will be more homogeneous (i.e., of higher purity) than the output of typical sorting systems, which would instead operate over the entire assembly and assign its classification based on the aggregate response of all materials in the assembly.

The exemplary embodiments include mechanisms and methods that combine to enable new tasks and that feature application-specific needs that are not found in the state-of-the-art. For example, the multiple modalities of sorting and separation featured in the exemplary embodiments may include the use of equipment for drying machined particles, so that they are ready for trade. The term “ready for trade” refers to processing parts to the extent necessary to meet market expectations regarding levels of purity, absence of noxious substances, removal of solvents, ability for inspection and transportation, and other expectations.

As a further example, consider a batch of post-consumer plastic scrap parts containing a mix of high density polyethylene (HDPE), polypropylene (PP), polyethylene terephthalate (PET), polyvinyl chloride (PVC), all of which have economic value for subsequent use as feedstock material for new parts of the same material, but only if they are separated from each other. Such batches also typically contain a small amount of metal, considered a contaminant that brings negative consequences to subsequent processes. In the state-of-the-art, separating this mix using only gravimetric methods (e.g., flotation) may output HDPE and PP on the light portion and PET, PVC, and metal on the heavy portion; neither portion is ready for trade because of material inter-contamination.

On the other hand, exemplary gravimetric methods configured in accordance with certain aspects of the invention when combined with the exemplary multi-modal sensing featured in the present disclosure enable the separation of HDPE and PP in the light stream, and therefore parts made from those materials are sufficiently pure for trade after processing by at least some embodiments of this invention, but current scrap markets expect plastic flakes washed and dried.

Thus, in accordance with certain aspects of the invention, systems and methods described herein may combine washing and drying parts in one system, and operating such a system in view of this combination presents unique challenges that are addressed by the exemplary embodiments featured herein. Furthermore, in the exemplary embodiments, the aforementioned combination may also enable the separation of PET and PVC, even though those portions may not initially be ready for trade because metal has not been removed from them. Nonetheless, combinations of, by way of non-limiting example, electromagnetic sensors for detecting metal, gravimetric separation methods, and optical detection methods make it possible to remove metal from PET and PVC portions.

As yet another example of the advantages of the presently described embodiments, the capability of separating a mix of parts made of PVC, PET, PP, HDPE, and metal enable the embodiments’ application on assemblies of parts made of those materials. This gives rise to the need for a mechanism for disassembly of parts and part size reduction such as shredding, which is yet another feature of the disclosed novel systems.

Furthermore, because in one or more embodiments featured herein, the plurality of machined particles to be sorted is dispersed in a fluid, no dust is generated during sorting. Moreover, in one or more embodiments, the dimensions of the fundamental unit cell in the machine where the sorting happens, or “sorting cell”, are much smaller than what is achievable in typical sorting systems and can route parts to a greater number of different bins. Therefore, with the one or more embodiments, it is possible to build sorting systems with small capacity and with commensurately small footprints that are practical for use in low-volume applications neglected by current (large-scale) systems.

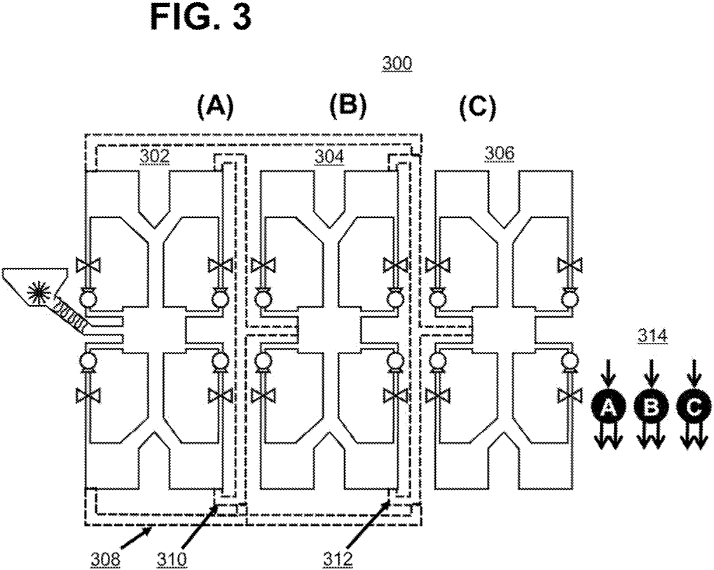

In one exemplary embodiment, a sorting system can be achieved using two or more sorting units. The two or more units can be mated, manually or automatically, using a mechanism, as shall be discussed below with respect to FIGS. 3-5. In this exemplary embodiment, the multiple sorting units forming the whole system has several advantages, when considering the sorted materials available at the output of the system. One advantage is that the homogeneity of the sorted material can be increased by connecting the multiple sorting units in series, each unit contributing in successively enhancing sorting fidelity. Another advantage is that the capacity of the sorting system can be scaled up or down by varying the number of sorting units operating in parallel. Another benefit is that the number of different materials sorted can be increased by branching out sorting units (connecting them in series and in parallel). Furthermore, the connection between multiple sorting units, from the same system or from separate systems, can be made configurable such that the system can adapt its connection topology (per user input or automatically) to change the throughput, number of sorting groups, and purity of each group, on the fly in response to external conditions (e.g., changes in price of the material sorted) or internal conditions (e.g., partial mechanical failure of the system). This makes it so that a given system can be used to sort materials in ways that currently require different types of equipment and can even be later reprogrammed to sort materials in a different way.

In an embodiment, the inlet where parts are introduced into the system leads to a fluidic section with a cross-sectional area relatively large compared with other fluidic cross-sectional areas in the system, such that the average fluid flow velocity decreases. The decrease in average fluid flow velocity causes the viscous forces of the fluid on the parts to decrease, allowing gravitational forces to govern whether any given machined particle moves towards the upper or the lower portion of this fluidic section according to the relative material density of the machined particle compared to the fluid. This feature enables the sorting of mixtures of parts that are lighter and heavier than the fluid, i.e., gravimetrically. This is particularly useful when processing assemblies of parts that contain multiple materials that are hard to identify using sensors but that readily separate according to gravity, such as certain types of plastics, and more specifically and without loss of generality assemblies containing HDPE and PET. The combination of these two materials is used increasingly in many beverage bottles (in which the body is made of PET, and is heavier than water, and the cap is mainly HDPE, and is lighter than water) largely because the ease with which the two materials can be separated using flotation methods. There are other situations when it is desirable to separate materials that are readily separated by gravimetric approaches for which embodiments of the invention is intended to process, such as when processing consumer electronics containing circuit boards made of a heavier-than-water fiberglass composite material commonly known in the trade as FR4, and an outer case made of acrylonitrile butadiene styrene (ABS), a material that is lighter than water. As such, the embodiments in their structural implementations and in their associated methods of operation reflect a stark departure from legacy sorting technologies. For instance, an exemplary system as described herein can enable a degree of processing flexibility unparalleled by current systems, which rely on separate lines to separate different types of material, at much lower capital expenses. Thus, exemplary systems as described herein can be small enough to capture recyclable material that typical systems, and the supply chain designed around them, currently ignore and are ill-positioned to capture and process profitably. The one or more embodiments can provide high-fidelity and high-throughput sorting for low-volume applications, which can be, for example and not by limitation, about 400 lbs./hr. Additionally, embodiments of this invention combine multiple processing steps into a single system, enabling feedback and measurement-based automation and significantly advancing the benefits for a user.

Furthermore, the one or more embodiments are configured to separate products composed of several types of materials (e.g., complex products, consumer electronics). Such embodiments expose the parts introduced into the system to, by way of non-limiting example, mechanical, chemical, physical, thermal, or biological pre- or post processing steps. For example, the fluid may contain potassium iodine in order to remove gold from the parts presented to the system. In another exemplary embodiment, the fluid may contain caustic solutions in order to dissolve adhesives holding labels and parts on the material presented to the system. Other pre-processing and post-processing steps include, but are not limited to, shredding, milling, and other forms of size-reduction methods; mechanical stirring, washing, centrifugation, dehydration, and blow drying.

When applying size reduction methods to assemblies or parts introduced into the system, a desirable reduction size is related to the dimensions of fluidic paths the part will follow in the system in order to avert parts becoming obstructed in said paths. Also, another desirable reduction size is related to the characteristic dimensions of features in assemblies made of heterogeneous composition, since fragmenting an assembly into such size increases the likelihood that the parts with reduced size will each have a heterogeneous composition compared to the original assembly.

For example, one can consider the characteristic feature dimension of circuit boards to be approximately 5-10 mm, as it relates to the general size of palladium-bearing discrete components and of circuit pads covered in gold; the characteristic feature dimension of plastic packaging to be approximately 10-30 mm, as it relates to the general size of HDPE caps in the bottles of a wide range of consumer products. In general, smaller reduction sizes result in material that is more homogeneous, because each part is more likely to be heterogeneous, and also likely to take a longer time to process, because the number of individual parts to be separated is greater.

In at least some embodiments the washing can occur through centrifugation, where parts are spun in a cylindrical cavity, creating friction between the particles with a cleaning effect, as fluid is continuously or intermittently introduced into the cavity to rinse away dissolved impurities. The extent to which impurities dissolve will depend on the type of assemblies being processed, with common impurities including graphite powders released by zinc-graphite batteries, highly viscous food residue such as peanut butter, and paper labels on consumer products.

In many exemplary applications of the invention, the sorted parts stored in the bins may be traded, and therefore it is convenient for the parts to be processed in ways that facilitate trade. One such way is by removing as much fluid as reasonably possible before the parts are released by the system. A preferred way to achieve this, without loss of generality, includes centrifugation: i.e., by spinning the bin holding the parts while water is pumped out of it. Other ways to remove the fluid in the parts, without loss of generality, includes blowing heated or dehydrated gasses through the bin, heating the bin contents with a radiative, inductive, or conductive heat source, reducing the vapor pressure of the bin. Those skilled in the art will appreciate that these methods can be combined to enhance their action.

They are further configured to separate waste consisting of highly-heterogeneous waste flows, and they are configured to find rare materials from a plurality of materials, i.e., finding “needles in a haystack.” In the latter case, an example may be the high-fidelity retrieval of tantalum capacitors from discarded electronic products.

One or more embodiments employ additives to the fluid that will actively or passively support the separation and sorting of parts. In one exemplary embodiment, the fluid may contain small amounts of anti-foaming agents in order to reduce air bubbles in the fluid that may disrupt functioning.

In one exemplary embodiment, the apparatus can include a small channel in which the particles to be sorted flow, one or more sensors that collect information on the elemental composition of the particles, one or more bifurcations downstream from the sensors, actuators that control the flow in the channel and its bifurcations, and a control system that activates the actuators to control the flow in the channel based on information from the sensors such that particles of interest flow down specific channels in the bifurcation. In another exemplary embodiment, the apparatus can include one or more channels as just described, with the particularity of having its flow primarily travel in the same direction as gravity; another or more channels as just described, with the particularity of having its flow primarily travel in a direction opposite to gravity; and another channel to which the aforementioned channels are connected, and through which parts are directed to the channels.

The sensors in the channel can be of different types, such as optical (for light of wavelengths of about 300-10,000 nm), electrical (for measuring electrical impedances), magnetic (to measure the electron spin resonance frequency), or X-ray detector. A sensor as defined herein does not necessarily exclude an excitation source configured to produce a signal that interacts with the particles and then reaches a detector. For example, for an optical sensor, a light source and a detector for detecting light reflected from the particles may be part of the sensor. Several non-limiting embodiments are described further below with reference to the accompanying drawings.

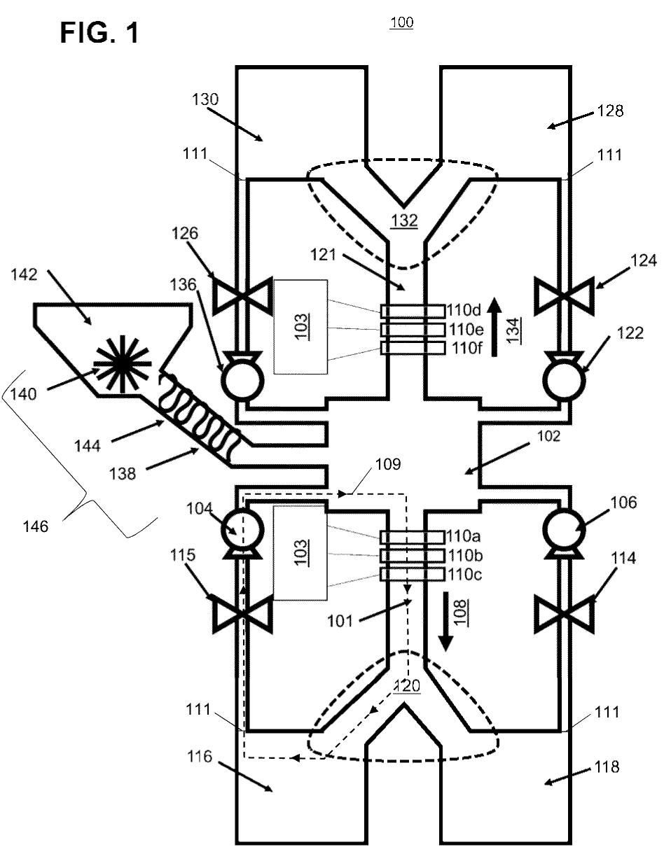

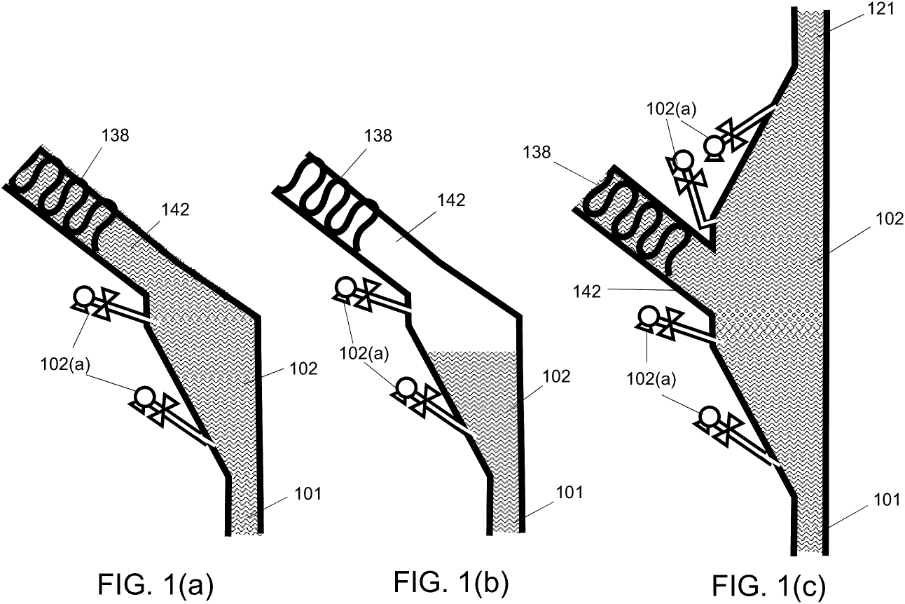

FIG. 1 illustrates a system 100 according to certain aspects of an embodiment. The system 100 may be filled with a fluid that serves to carry machine-processed particles (e.g., shredded, milled, or subjected to other forms of mechanical size reduction) through the system. Fluid may be introduced to system 100 through a filling port (not shown), such as into an input fluidic section 102, although those skilled in the art will recognize that a filling port may be placed anywhere else in the system. As configured, and with the fluid flowing in the input fluidic section 102, the system 100 is ready for sorting parts according to one or more modalities described below. In one use scenario, unsorted parts and assemblies of unsorted parts may be introduced into the system 100 through an input section 146 via an inlet manifold 142 where, for example, a shredding mechanism 140 mechanically reduces the size of assemblies and parts introduced to inlet manifold 142. After shredding mechanism 140, parts are preferably washed by a washing mechanism 144 (the construction of which will be well known to those skilled in the art and is thus not further described here) and a screw conveyor 138 that controls the direction and rate of movement of machined particles into fluidic section 102. In some embodiments, input section 146 can also include other aforementioned forms of pre-processing. From screw conveyor 138, machined particles are introduced into fluidic section 102, which is irrigated with flow that exists through one or more branches 101 and 121, which in the exemplary configuration of FIG. 1 are located in the upper and lower ends of the fluidic section 102. Notably, while FIG. 1 shows both a lower branch 101 and an upper branch 121, those skilled in the art will recognize that only one such branch may be provided in certain configurations. With particular reference to FIGS. 1(a) - 1(c), fluidic section 102 exhibits a cross-sectional area that is larger near where parts enter from screw conveyor 138 and smaller near branches 101 and 121, such that the fluid flow velocity is relatively lower near screw conveyor 138 and higher near branches 101 and 121. As a consequence, parts entering fluidic section 102 from screw conveyor 138 experience relatively low fluid drag forces and their trajectory is influenced by the difference between the density of the part and the fluid, if any.

In this regard and as shown in FIG. 1(a), if a downward-only flow is to be utilized, the inlet to fluid section 102 may be filled with liquid along with the entire chamber of fluidic section 102. In this configuration, screw conveyor 138 pushes material down, optionally assisted by fluid jets 102(a), some of which push the machined particles themselves and others of which assist by manipulating the flow, such as by creating low pressure regions through venturi effects. In this configuration, system 100 may include a gate, valve, or the like that seals off branch 121 so that all machined particles are directed to branch 101, or alternatively only branch 101 may be provided. Likewise, and as shown in FIG. 1(b), fluidic section 102 (having like configuration to that of FIG. 1(a)) may be filled only partially with fluid, in which case the screw conveyor 138 drops machined particles over the liquid-air interface, optionally assisted by jets 102(a) spraying generally toward the liquid-air interface, and preferably other jets 102(a) to assist in delivering machined particles into the system 100. Finally and with reference to FIG. 1(c), if both downward and upward flows are to be utilized, the inlet to fluidic section 102 may be filled with liquid along with the entire chamber of fluid section 102, with jets 102(a) again assisting machined particles towards the desired destination.

As machined particles move within fluidic section 102 towards either of branches 101 and 121, they experience greater drag forces by the fluid due to increasing flow velocity, and the relative effect of buoyancy forces on the machined particles diminishes. The unsorted machined particles may flow with the fluid in one of directions 108 and 134. The unsorted machined particles may be composed of various materials. For example, and not by limitation, the unsorted machined particles may be pieces of a printed circuit board that has been broken apart to make the plurality of unsorted machined particles. In this configuration, the fluid will flow predominantly through either of the paths in the flow bifurcations at the junction 120 or 132 for ultimate collection in bins 116, 118, 128, and/or 130 as discussed in greater detail below.

As machined particles are introduced into the system 100 via the inlet manifold 142 and into fluidic section 102, they move with the fluid flow in branches 101 and 121 past a plurality of sensors (of which sensors 110a-110f are shown). The information collected by these sensors about the machined particles is fed to a control system 103 that is communicatively coupled to the sensors 110a-110f. One of skill in the art will readily recognize that a communication link between the sensors 1 10a-1 10f and the control system 103 may be wireless, or a set of wired connections, or a combination of wired and wireless connections.

Control system 103, based on the information received from sensors 110a-110f, may determine which of bins 116, 118, 128, and/or 130 are to receive a first set of machined particles, the first set of machined particles being substantially the same (e.g., the same type of material). Once the determination is made of which bins are to receive a set of machined particles, control system 103 may actuate pumps 104, 106, 122, and/or 136 and valves 114, 115, 124, and 126 to route the machined particles to the intended one of bins 116, 118, 128, and 130. Thus, in an exemplary use case, control system 103 may determine from sensors 110a-110c that machined particles of a particular type are to be directed, for example, to bin 116. With that determination, and upon detection that a machined particle travelling through branch 101 is of that particular type, control system may then open valve 115 and initiate pump 104 to cause flow in the direction of arrow 109, in turn causing the first set of machined particles of that particular type to flow towards bin 116. Preferably, a screen 111 may be provided at a flow exit from bin 116 (as well as at the flow exits from bins 118, 128, and 130) to allow fluid to continue to flow but trapping machined particles inside of bin 116. A second set of machined particles may include unsorted machined particles or machined particles that are similarly sorted into bin 118 through activation of valve 114 and pump 106 according to another criterion established by the control system 103.

In order to discriminately sort the differing types of machined particles travelling through branch 101 into one of bins 116 or 118, the appropriate pump and valve for the selected bin are preferably activated for a short time in order to divert a machined particle of a given type to its intended bin. To effect this, the respective valve and pump associated with a bin may be activated for, by way of non-limiting example, 10-500 ms, which period will be just long enough for deflecting the trajectory of the machined particle. Thus in an exemplary use case, for two machined particles (X, Y) flowing close together through branch 101, with machined particle X intended for collection in bin 116 and machined particle Y intended for collection in bin 118, control system 103 activates only pump/valve 104/115 as particle X reaches junction 120 to route machined particle X to bin 116, and then quickly changes to activate only pump/valve 106/114 for a similarly short time to route machined particle Y towards bin 118.

In certain configurations, the fluid may be pumped back to the inlet manifold 142, to fluidic section 102, washing mechanism 144, screw conveyor 138, as well as a combination of these components so that it can be used to move other machined particles through the system 100. As such, the fluid is reusable.

In a configuration of system 100 that includes upper branch 121 directing machined particles to bins 128 and 130, and particularly lighter machined particles that will tend float or suspend above heavier particles in fluidic section 102 that are ultimately directed to lower branch 101, control system 103 may similarly determine from sensors 110d-110f that machined particles are to be directed to either of bins 116 and/or 128. With that determination, control system may then open valve 124 and initiate pump 122 to cause flow towards bin 128, and/or may open valve 126 and initiate pump 136 to cause flow towards bin 130, all in the same manner as discussed above with regard to machined particles in lower branch 101.

Those skilled in the art will recognize that while four pumps 104, 106, 122, and 136 are shown in FIG. 1, the flows necessary to route machined particles to their intended bins need not be controlled by separate pumps, and that instead system 100 may be equipped with a single pump with flows (including the flows discussed above that are initiated to discriminately sort machined particles into separate bins) controlled simply by opening and closing the appropriate valves 114, 115, 124, and 126 to initiate the desired flow path.

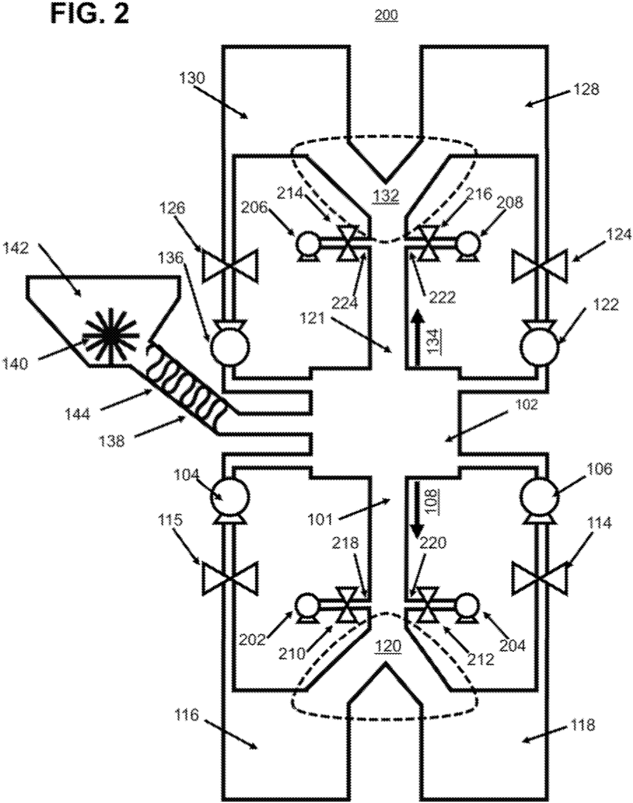

FIG. 2 illustrates a system 200 configured similarly with respect to system 100. In system 200, control system 103 is not shown for ease of description. In addition to controlling pumps 104, 106, 122, and 136 to establish the fluid flow in the input fluidic section 101, the control system may further control pumps, 202, 204, 206, and 208, and valves 210, 212, 214, and 216 to effect changes in the flow pattern in branches 101 and 121 via inlets 218, 220, 222, and 224. For example, upon receiving information from one or all of the sensors 110a-110f, the control system 103 may cause the valve 212 to open and the valve 210 to close, pumping fluid into branch 101 from a side direction for a short time as discussed above, which would effectively force the bulk of the flow to guide machined particles to the bin 116. As such, in this implementation secondary flows in a direction other than directions 108 or 134 may be used to alter the primary flow (i.e., the flow in branches 101 or 121) before their bifurcations at junction 120 and 132, respectively. Those skilled in the art will recognize that fluid pumped through valve 210, 212, 214, and 216 may be supplied, for example, from the fluid in the rest of the system 200, and that again flows may be initiated with only a single system pump through opening and closing of the valves.

FIG. 3 illustrates an assembly 300 according to an embodiment. The assembly 300 may include a plurality of systems like the systems 100 or 200. In FIG. 3, systems 302, 304, and 306 are shown for the purpose of describing the assembly 300. In other words, one of skill in the art will readily recognize that any number of systems can be arranged in the assembly 300 without departing from the scope of the present disclosure.

In the assembly 300, each one of the systems 302, 304, and 306 (also denoted A, B, and C, respectively) may be equipped with conduit 308, 310, and 312 that can connect it to a neighboring system. When such conduits are not connected (as indicated by the dashed lines), the assembly 300 simply functions as three separate systems each having an independent input section (only one of which is shown in FIG. 3 for simplicity of the instant description). This function is illustrated in the panel 314, showing the three systems and their respective outputs.

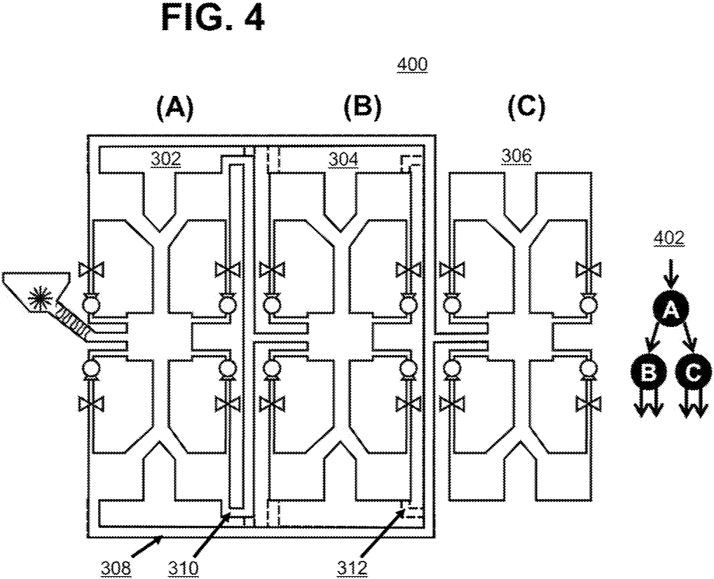

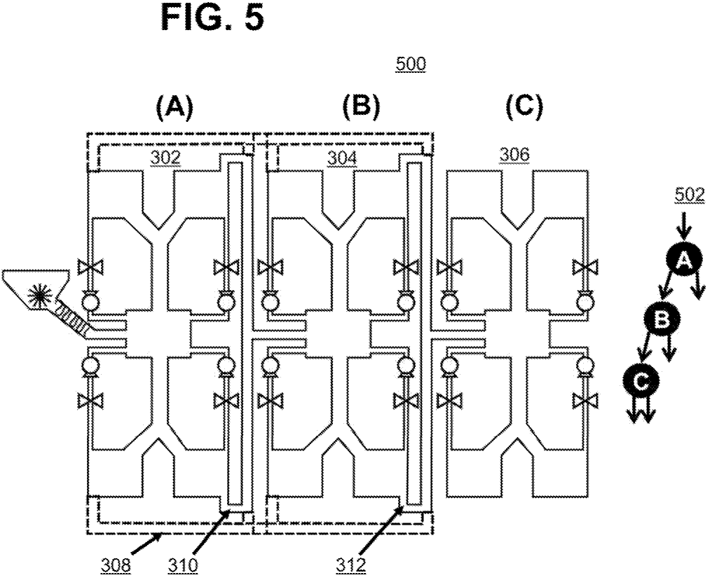

FIG. 4 illustrates an assembly 400 according to an embodiment. The assembly 400 illustrates a case where the systems 302, 304, and 306 are, unlike in FIG. 3, connected to provide an alternate function. For example, a first conduit 308 of the system 302 is connected to the system 306 and a second conduit 310 of the system 302 is connected to the system 304, while conduit 312 is not connected. This arrangement gives the assembly 400 the function illustrated in the panel 402. Specifically, the assembly 400 functions as a primary system (302) with its outputs fed to two secondary systems (304 and 306) for further processing. Similarly, in FIG. 5, yet another arrangement is depicted in the assembly 500. In this case, as shown in the panel 502, the systems 302, 304, and 306, are arranged serially to make a cascade of systems with one of the outputs feeding to the input of the next system through conduits 310 and 312, and conduit 308 disconnected.

FIGS. 3-5 illustrate yet another advantage of the exemplary systems described herein. For example, multiple instances of the systems can be tiled together to make multi-processing units, where each instance has its own particular configuration or is similarly configured to the other instances in the arrangement. One of skill in the art will readily recognize that any combinations of the arrangements 300, 400, and 500 can be made, and further, that other arrangements not described here can be made without departing from the scope of the present disclosure. Furthermore, it is noted that each system in the arrangement may be connected to the next via a mechanism that includes, but is not limited to, a flange, a connector, or a mating section or the like.

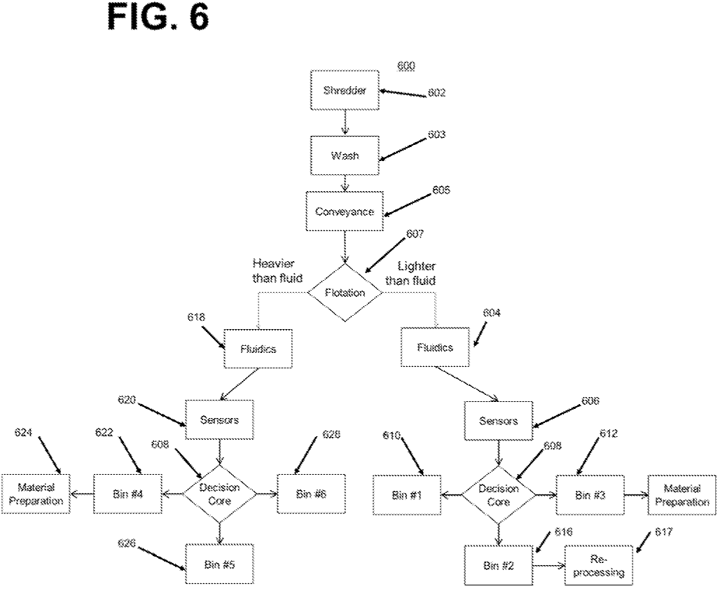

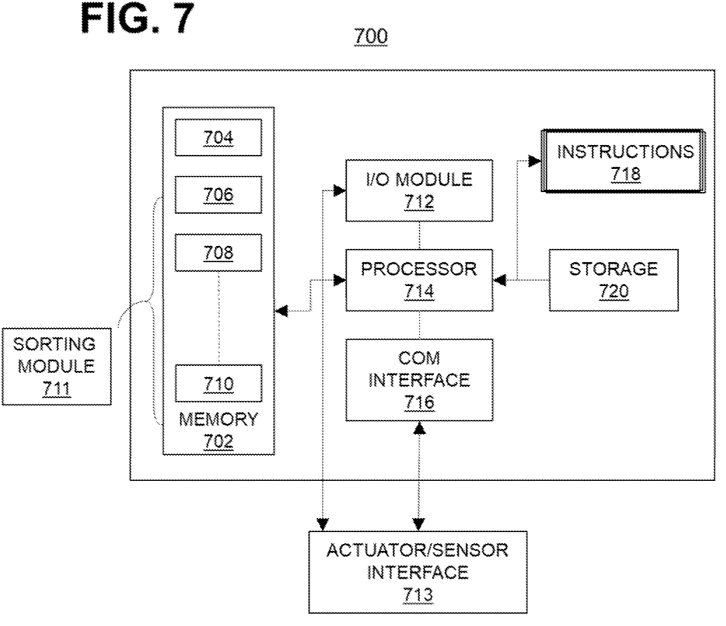

FIG. 6 illustrates a flow chart of a method 600 according to an exemplary embodiment. The method 600 first includes preparing the material to be sorted at step 602. This may include grinding the material to make it into a plurality of smaller machined particles. At step 603, the method 600 includes washing machined particles from solid and non-solid contaminants. At step 605, the method 600 includes conveying machined particles at a controlled rate to the following step. At step 607, the method 600 includes immersing machined particles in a fluid, which will lead to their separation according to the relative density of their materials and that of the fluid. At step 607 the portion of the machined particles that is lighter than the fluid will move on to step 604 and the portion that is heavier than the fluid will move on to step 618. At step 604, the method 600 includes feeding the smaller machined particles that are lighter than the fluid to the fluidic section where sensing is effectuated at step 606, as described above in regards to the one or more exemplary sensing modalities discussed. Upon routing the sensing data being received by a decision core, the decision core at step 608, which may be an application-specific computing apparatus (see FIG. 7), instructs the actuators of the system to route a first batch of sorted machined particles to a first bin at 610 and/or a second batch of sorted machined particles to a second bin at 612 and/or a third batch of sorted machined particles to a third bin at 616. At step 617, the materials in the third bin, for example and not by limitation, can be inputted to another like system where the method 600 may be repeated as described above for reprocessing.

At step 618, the method 600 includes feeding the smaller machined particles heavier than the fluid to the fluidic section where sensing is effectuated at step 620, as described above in regards to the one or more exemplary sensing modalities discussed. Upon routing the sensing data being received by the decision core 608, the decision core 608 instructs the actuators of the system to route a first batch of sorted machined particles to a first bin at 628 and/or a second batch of sorted machined particles to a second bin at 622 and/or a third batch of sorted machined particles to a third bin at 626. At step 624, the materials in the second bin, for example and not by limitation, can be inputted to another like system where the method 600 may be repeated as described above.

FIG. 7 illustrates a controller 700 (or system), according to further aspects of an embodiment. The controller 700 may be configured by programmable instructions to implement the decision core 608, among other functionalities associated with the method 600 and the other aspects of the systems and assemblies described in FIGS. 1-5. In the case of the assemblies 300, 400, and 500, the controller 700 can be a central unit controlling all of the systems in the assemblies or each system in the assembly can have its own controller like the controller 700, which can cooperatively function with other controllers in the assembly to achieved desired tasks.

The controller 700 can include a processor 714 having a specific structure. The specific structure can be imparted to the processor 714 by instructions stored in a memory 702 and/or by instructions 718 fetchable by the processor 714 from a storage medium 720. The storage medium 720 may be co-located with the controller 700 as shown, or it can be remote and communicatively coupled to the controller 700. Such communications can be encrypted.

The controller 700 can be a stand-alone programmable system, or a programmable module included in a larger system. For example, the controller 700 can be included in the control system 103 described previously. The controller 700 may include one or more hardware and/or software components configured to fetch, decode, execute, store, analyze, distribute, evaluate, and/or categorize information. In the case that a system contains more than one group of sensors sharing an exclusive fluidic branch, such as 101 for sensors 110a-c or 121 for sensors 110d-f, then the functions of decision core 608 associated with each group of sensors can be performed either by a dedicated controller 700 for each group of sensors, by a single controller 700, or a combination of shared and dedicated controllers.

The processor 714 may include one or more processing devices or cores (not shown). In some embodiments, the processor 714 may be a plurality of processors, each having either one or more cores. The processor 714 can execute instructions fetched from the memory 702, i.e. from one of memory modules 704, 706, 708, or 710. Alternatively, the instructions can be fetched from the storage medium 720, or from a remote device connected to the controller 700 via a communication interface 716. Furthermore, the communication interface 716 can also interface with an actuator/sensor interface 713, i.e., with electronic hardware that controls the flow rates, valves, and receive sensor data through the various parts of the above-described systems or assemblies of systems.

Without loss of generality, the storage medium 720 and/or the memory 702 can include a volatile or non-volatile, magnetic, semiconductor, tape, optical, removable, non-removable, read-only, random-access, or any type of non-transitory computer-readable computer medium. The storage medium 720 and/or the memory 702 may include programs and/or other information usable by processor 714. Furthermore, the storage medium 720 can be configured to log data processed, recorded, or collected during the operation of controller 700. The data may be time-stamped, location-stamped, cataloged, indexed, encrypted, and/or organized in a variety of ways consistent with data storage practice. By way of example, the memory modules 706 to 710 can form a sorting module 711 that includes instructions that, when executed by processor 714, cause processor 714 to perform certain operations consistent with the method 600 described above. The sorting module 711 may contain instructions that are fetched from an instruction set 718 and/or from one or more remote devices via an I/O module 712 and/or through the communication interface 716.

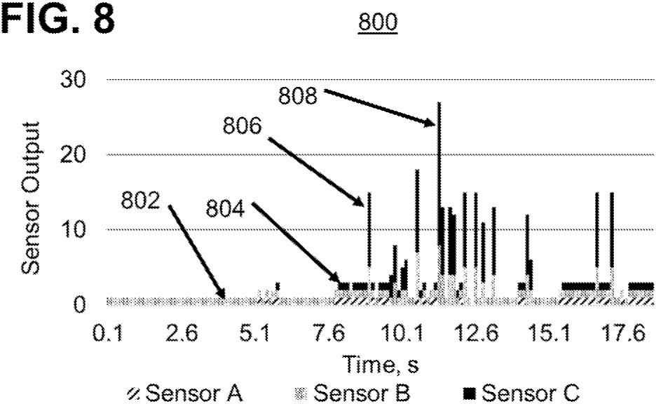

In FIG. 8, the graph 800 shows the typical output of three optical sensors tuned to different wavelengths, A, B, and C, as a function of time while a plurality of machined particles, all of the same type, move through a branch analogous to 101. Sensors A, B, and C, are analogous to sensors 110a-110f, and typically, and without loss of generality, output a baseline value 802 in the absence of machined particles. As machined particles move through the apparatus, the set of sensors provide outputs that are different from the baseline, such as 806 and 808. The baseline may drift in value over time, producing spurious outputs, such as 804, that may need to be filtered or otherwise accounted for by the decision core 608.

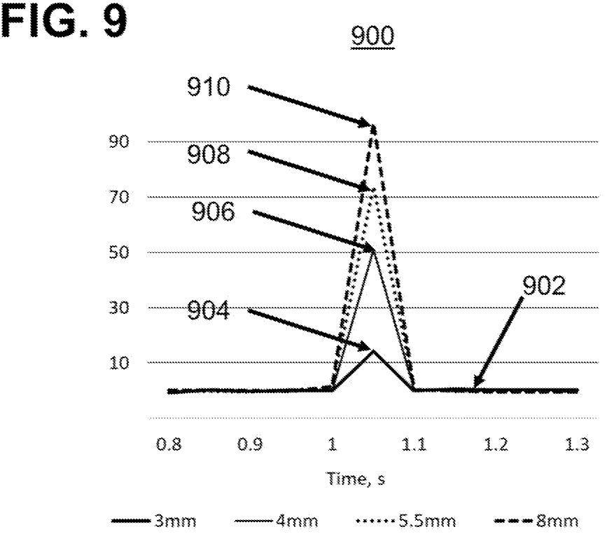

In FIG. 9, the graph 900 shows the typical output of an electromagnetic sensor tuned to detect ferromagnetic metals as a function of time while a plurality of ferromagnetic machined particles of different size move through a branch analogous to 101. The electromagnetic sensor is analogous to sensors 110a-110f, and typically, and without loss of generality, output a baseline value 902 in the absence of machined particles parts. As machined particles move through the apparatus the set of sensors provide outputs that are different from the baseline, and that are greater in for larger parts, with peak values 904, 906, 908, and 910 corresponding to parts 3, 4, 5.5, and 8 mm in diameter respectively.

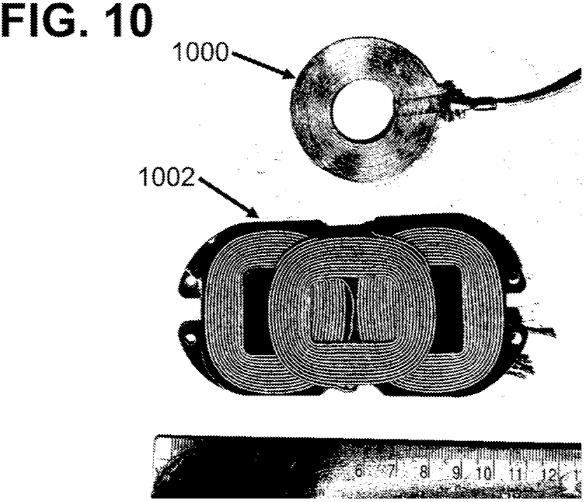

FIG. 10 shows a photograph of various coils used in the detection of ferrous and non-ferrous metals to produce the outputs presented in FIG. 9. 1000 is a single detecting electromagnetic coil, while 1002 is an assembly that combines multiple coils at a fixed and known configuration in order to supplement the information provided to the decision core 608.

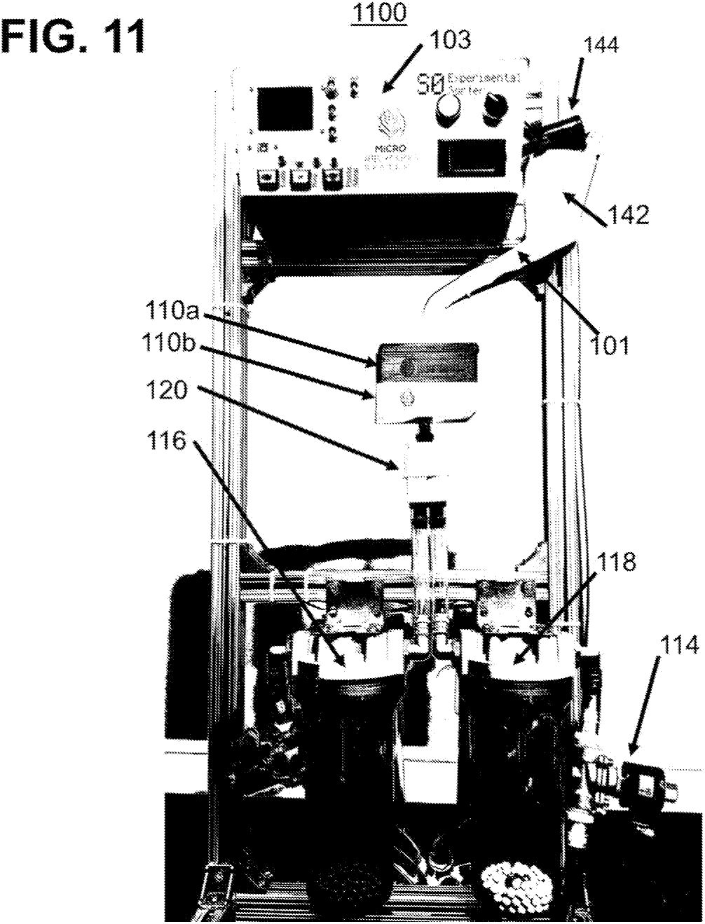

FIG. 11 shows a photograph of a system 1100 which is an embodiment consistent with the teachings featured herein. Components readily visible include control system 103, the fluidic inlet 142, washing mechanism 144, branch 101, sensors 110a and 110b, junction 120, bins 116 and 118 (this embodiment is outfitted with two more bins not directly visible), and also control valve 114. This depiction of embodiment is not exhaustive, in that it does not show all of the elements disclosed and it is meant to communicate concrete exemplary embodiments without loss of generality.

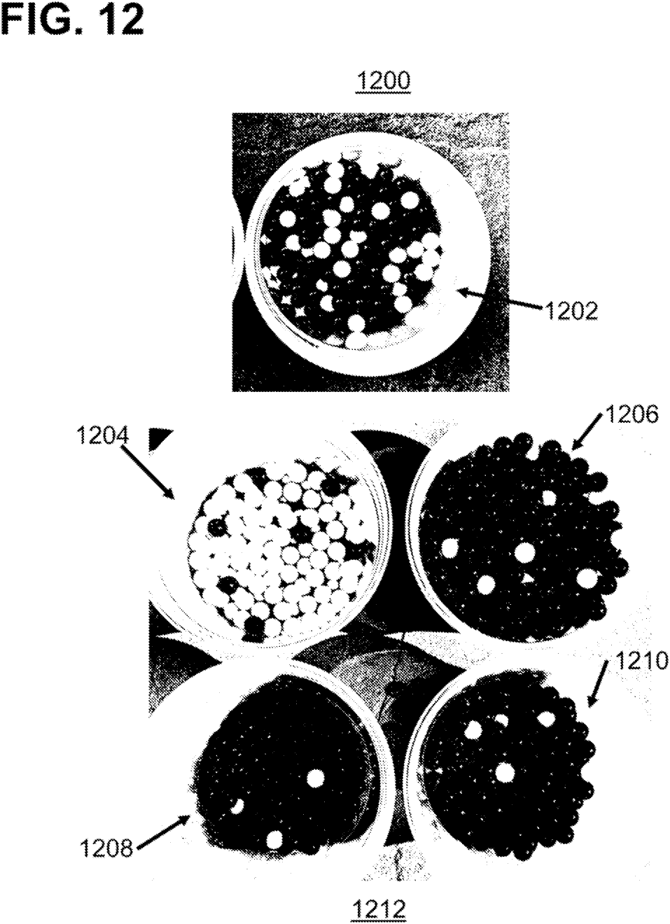

FIG. 12 shows two photographs. Photograph 1200 shows a batch of 4 different types of parts mixed together in roughly equal proportions 1202, such that each type makes up roughly 25% of the total. Photograph 1212 shows these same parts after they were processed by system 1100 and separated into 4 different portions, each enriched from the proportion ^{~}25% as before processing. Parts in 1204 were found to be 92% of a predominant type, parts in 1206 were found to be 98% of a predominant type, parts in 1208 were found to be 89% of a predominant type, and parts in 1210 were found to be 57% of a predominant type.

Generally, an embodiment consistent with the teachings featured herein may include an apparatus, like the systems 100 or 200, whose structural configuration allows low-volume, high-throughput, and high-fidelity sorting and/or separation operations. This exemplary apparatus may include a fluidic section that comprises an input section. The fluidic section may be configured to receive a fluid including a plurality of parts at the input section. For example, and not by limitation, the fluidic section may be configured to receive the fluid at an inlet port of the fluidic section. The fluidic section may include at least two branches extending from the input section, and each of these at least two branches may have an outlet through which the fluid or part of the fluid may be routed. The apparatus may include a set of sensors configured to capture information about the plurality of machined particles in the fluidic section. The apparatus may further include a set of actuators configured to effect, based on the information, a change in a movement of a set of machined particles from the plurality of machined particles such that the set of machined particles is distributed via the fluid to at least one of the at least two branches. The apparatus may further include features and mechanisms to modify the parts presented to the system in order to improve the function of the system, such as mechanisms for reducing the size of parts, separating machined particles made of different composition from each other, expose the machined particles to physical or chemical agents, or remove an undesirable fraction of the machined particles.

In the embodiment, specified machined particles from the set of machined particles, one (or generally a subset of machined particles) of the set of machined particles can include a metal, while another machined particle (or generally another non-overlapping subset) can include non-metallic machined particles. The embodiment may be configured to allow low-volume sorting and/or low-volume separations. For example, the apparatus may be configured with a volume of fluid, taken from an inlet of the input section to an outlet of one of the at least two branches, of less than about 5 liters. Generally, this may yield a throughput of sorted machined particles of less than about 400 lbs./hr.

Furthermore, in the exemplary apparatus, the set of actuators can include an actuator selected that is either a valve, a pin, or a jet of secondary fluid. Generally, without limitation, the actuators may be actuators that are all the same or they may be a set of different actuators. In the case of a jet fluid actuator, the fluidic section 102 may include side ports through which a jet of secondary fluid may be forcibly introduced in the fluid (here the primary fluid) in order to effect a change in the trajectory of the plurality of parts. In this case, the jet of secondary of secondary fluid may be either a liquid or a gas.

The apparatus can further include a set of sensors. Without limitation, but by example only, the set of sensors may include an electromagnetic sensor, a mechanical sensor, an acoustic sensor, a radiation sensor, and an optical sensor. One of ordinary skill in the art will readily recognize that all of the sensors in the set may be of one type or that the set of sensors may be the combination of several types of sensor; in the latter case, several sensing modalities can be used, without departing from the scope of the present disclosure.

In the case of an electromagnetic sensor, the sensor may be configured to capture information about the complex formed by the fluid and the parts located therein based on a single operating frequency. Without limitation, but by example, this single frequency may be about 10 kilohertz (kHz). In an alternate embodiment, the electromagnetic sensor may be configured to capture the information using a plurality of operating frequencies. For example, and not by limitation, the sensor may be configured to operate at frequencies of about 100 Hz, 10 kHz, and 1 MHz. One of skill in the art will readily recognize that generally, two or more frequencies can be used, without departing from the scope of the present disclosure.

In the case of a mechanical sensor, the sensor may be configured to detect a force or displacement. In the case of an acoustic sensor, the sensor may be configured to detect ultrasounds. In the case of an optical sensor, the information captured may be based on either a reflectance, an absorbance, a transmittance, a fluorescence, a diffraction, or a scattering profile. In certain configurations, a combination of one or more or of all these modalities may be used without departing from the scope of the present disclosure. In the case of a radiation sensor, the sensor may be an X-Ray detector, and the information captured may be based on detecting an X-Ray having an energy in the range of about 1 keV to about 100 keV. In yet another alternate embodiment, the range of the detected X-Ray may be in the range of about 1 keV to about 10 keV.

Another embodiment consistent with the teachings featured herein may be an assembly including two or more apparatuses like the one described above, where all the apparatuses in the assembly have the same configuration or where at least two apparatuses in the assembly have distinct configurations. For example, in the latter case, an embodiment may feature a first apparatus including a set of sensors based on optical detection and second apparatus including a set of sensors based on mechanical detection. Generally, one of skill in the art will readily appreciate that combinations of distinct configurations may be achieved without departing from the scope of this disclosure, whether the point(s) of distinction between configurations is based on the sensing modalities contemplated herein or on the physical specification of the fluidic section in each apparatus.

In one exemplary implementation, each apparatus of the assembly may have the same or substantially similar configurations. Each apparatus may thus include a fluidic section including an input section. The fluidic section can be configured to receive a fluid including a plurality of parts therein. The fluidic section can include at least two branches extending from the input section.

The apparatus may include a control module configured to effect a change in a movement of a set of parts from the plurality of parts such that the set of parts is distributed via the fluid to at least one of the at least two branches. In this implementation, each apparatus has its own control module. In other implementations, there may be a central control module with peripheral hardware coupled with each apparatus in the assembly, where the peripheral hardware is configured to effect the change in the movement. The control module is configured to cause a force selected from at least one of a dielectrophoretic force, an electrophoretic force, an electrodynamic force, and a magnetophoretic force to be exerted on the plurality of machined particles. Lastly, the assembly may have a mechanism configured to mate a first apparatus from the set of apparatuses with a second apparatus from the set of apparatuses forming the entirety of the assembly.

Another embodiment consistent with the teachings featured herein may be an apparatus that includes a fluidic section having an input section configured to receive a fluid including a plurality of machined particles therein. The fluidic section can include at least two branches extending from the input section. The apparatus may include or it may be communicatively coupled to a control module configured to effect a change in a movement of a set of machined particles from the plurality of machined particles such that the set of machined particles is distributed via the fluid to at least one of the at least two branches. The control module can be configured to cause a force resulting from at least one of a dielectrophoretic force, an electrophoretic force, an electrodynamic force, and a magnetophoretic force to be exerted on the plurality of machined particles. In order to increase the overall speed of processing machined particles, exemplary systems can have multiple fluidic sections that work in parallel to each other and route the machined particles to the same or different bins as the other fluidic sections.

A system based on the teachings of the instant disclosure may be implemented as a stand-alone machine that is supplied with complex, heterogeneous material, and produces two or more output streams containing homogeneous materials. An exemplary system may be used in the recycling and the mining industries. Once processed by one such system, materials will have higher value, in terms of economic value, regulatory requirements, environmental benefits, processability by downstream systems, or in aspects other than those relating to the materials initially provided to the system as when input to the system.

Feeding the particles with a mechanism, such as a worm-gear, is important because the mechanism will keep a constant flow of particles despite buoyancy forces that would otherwise accelerate, slow, or prevent the movement of particles in the direction required by the mechanism. For example, in the case of a worm-gear pushing material down into a system flowing with water, lighter-than-water particles will resist being pushed into the system, whereas the worm-screw forces the material down and into the main sorting plenum for sorting

Mechanically reducing the size of the particles prior to feeding into the loading mechanism is important because it enables the automated sorting of whole-items and products, eliminating the most expensive and time-consuming step in recycling of electronics and other complex products.

The additives can chemically reach with some or all of the substances in the particle (e.g., selective reaction with solder; dissolving gold in aqua regia), physically interact with the part (e.g., dissolve the glue adhering paper labels to plastic parts; swell polymers inside stacked materials such that the material comes apart), or biologically (e.g., microorganisms capable of metabolizing PET; microorganisms that sequester heavy metals or rare earth elements) .

Additionally, additives may be provided to the system fluid in order to modify the viscosity of the fluid as may be desirable for processing of machined particles of particular compositions. Suitable additives for modifying the viscosity of the system fluid may include, by way of non-limiting example, synthetic polymers such as polyethylene glycol and polyvinyl alcohol, polysaccharides such as xantham gum or starches, and inorganic salts such as phosphates, carbonates, and thiocyanates.

Lastly, although the drawings describe operations in a specific order and/or show specific arrangements of components and are described in the context of recycling, separating particles, or extracting specific materials from a plurality of parts, one should not interpret that a specific order and/or arrangements of the components and/or steps of described methods limit the scope of the present disclosure, or that all the operations performed and the components disclosed are needed to obtain a desired result.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

What is claimed is:

1. An apparatus, comprising:
a machined particle input section;
a fluidic section in fluid communication with the machined particle input section at an inlet manifold of the fluidic section, the fluidic section being configured to receive at the inlet manifold a fluid including a plurality of machined particles therein, and at least one primary branch extending from the fluidic section, wherein a first primary branch is configured to force the fluid in a first direction;
a plurality of first secondary branches extending from the first primary branch;
one or more sensors configured to capture information about an elemental composition of the plurality of machined particles in the first primary branch; and
a set of actuators configured to effect, based on the information, a change in a movement of a set of machined particles having a common elemental composition from the plurality of machined particles such that the set of machined particles is distributed via the fluid to at least one of the plurality of two secondary branches.

2. The apparatus of claim 1, further comprising at least one fluid pump and a plurality of first valves operable to selectively divert flow of machined particles in the first primary branch to one of the first secondary branches.

3. The apparatus of claim 2, further comprising a first branch machined particle collection bin at the end of each of the first secondary branches.

4. The apparatus of claim 3, further comprising a first branch fluid return line extending from each collection bin and back to the fluidic section, wherein each of said first valves is positioned to control flow through each said return line.

5. The apparatus of claim 4, further comprising:
a second primary branch extending from the fluidic section and configured to force the fluid in a second direction;
a plurality of second secondary branches extending from the second primary branch;
one or more sensors configured to capture second information about an elemental composition of the plurality of machined particles in the second primary branch; and
a second set of actuators configured to effect, based on the second information, a change in movement of a second set of machined particles having a second common elemental composition from the plurality of machined particles such that the second set of machined particles is distributed via the fluid to at least one of the plurality of two second secondary branches.

6. The apparatus of claim 5, further comprising a plurality of second valves operable to selectively divert flow of machined particles in the second primary branch to one of the second secondary branches.

7. The apparatus of claim 6, further comprising a second branch machined particle collection bin at an end of each of the second secondary branches.

8. The apparatus of claim 7, further comprising a second branch fluid return line extending from each second branch collection bin and back to the fluidic section, wherein each of said second valves is positioned to control flow through each said second branch return line.

9. The apparatus of claim 2, further comprising a plurality of fluid inlets in said first primary branch and located between said fluidic section and said first secondary branches.

10. The apparatus of claim 9, further comprising a diverting valve in each said fluid inlet and configured to selectively inject fluid into the first branch from a side direction to further divert flow of machined particles in the first primary branch to one of the first secondary branches.

11. The apparatus of claim 1, wherein the fluidic section is configured to route parts that are heavier than the fluid to the first primary branch.

12. The apparatus of claim 11, further comprising:
a second primary branch extending from the fluidic section and configured to force the fluid in a second direction;
a plurality of second secondary branches extending from the second primary branch;
one or more sensors configured to capture second information about an elemental composition of the plurality of machined particles in the second primary branch; and
a second set of actuators configured to effect, based on the second information, a change in movement of a second set of machined particles having a second common elemental composition from the plurality of machined particles such that the second set of machined particles is distributed via the fluid to at least one of the plurality of two second secondary branches;
wherein the fluidic section is configured to route parts that are lighter than the fluid to said second primary branch.

13. The apparatus of claim 1, further including one or more fluid jets positioned to modify a trajectory of the plurality of machined particles.

14. The apparatus of claim 1, further including a size reduction apparatus configured to reduce a size of a plurality of parts to form said machined particles.

15. The apparatus of claim 1, further including a machined particle feeder configured to control a rate at which the plurality of machined particles enter the fluidic section.

16. The apparatus of claim 1, further including a washer configured to clean the plurality of machined particles.

17. The apparatus of claim 1, further including a washer configured to remove solvents from the plurality of machined particles.

18. The apparatus of claim 1, wherein the fluid contains substances that modify its viscosity.

19. The apparatus of claim 1, wherein the fluid contains chemical or biological agents selected to dissolve substances in the machined particles introduced into the fluidic section.

20. The apparatus of claim 1, wherein a machined particle in the plurality of machined particles is smaller than about 2.5 centimeters.

21. The apparatus of claim 1, wherein the plurality of machined particles include plastic.

22. The apparatus of claim 1, wherein the plurality of machined particles include a metal.
